(19) United States
(12) Patent Application Publication
(10) Pub. No.: US 2021/0360504 A1
(43) Pub. Date: Nov. 18, 2021

(54) METHOD AND APPARATUS FOR MOBILITY OPTIMIZATION

(71) Applicant: Telefonaktiebolaget LM Ericsson (publ), Stockholm (SE)

(72) Inventor: Zhang Zhang, BEIJING (CN)

(21) Appl. No.: 17/277,766

(22) PCT Filed: Aug. 12, 2019
(86) PCT No.: PCT/CN2019/100260

§ 371 Date: Mar. 19, 2021

(30) Foreign Application Priority Data
Sep. 21, 2018 (CN) PCT/CN2018/106905

(51) Int. Cl. H04W 36/32; H04W 36/00

(52) U.S. Cl. CPC H04W 36/32; H04W 36/00837; H04W 36/0058; H04W 36/0016

(57) ABSTRACT

Various embodiments of the present disclosure provide a method for mobility optimization. The method which may be performed by a first terminal device comprises identifying a second terminal device having mobility behavior similarity to the first terminal device. The mobility behavior similarity indicates that a difference in mobility behavior between the first terminal device and the second terminal device is within a predefined range. The method further comprises transmitting similarity signaling which indicates the mobility behavior similarity to a network node serving the first terminal device. According to the embodiments of the present disclosure, by use of sidelink, handover preparation may be performed for terminal devices with similar mobility behavior so that handover performance can be improved.

### FIELD OF THE INVENTION

The present disclosure generally relates to communication networks, and more specifically, to method and apparatus for mobility optimization.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device to device (D2D) communication features which targets at both commercial and public safety applications has been proposed. An extension for the D2D work may consist of supporting Vehicle-to-everything (V2X) communication, which includes any combination of direct communications among vehicles, pedestrians and infrastructure. Wireless communication networks such as long-term evolution (LTE) and new radio (NR) are expected to use V2X services and support communication for V2X capable user equipment (UE) with mobility. Thus, it is desirable to provide mobility management for the V2X capable UE efficiently.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network such as LTE and NR, V2X services may be used for various applications to implement different communication requirements, for example, vehicles platooning, extended sensors, advanced driving, and remote driving. The V2X capable UE such as a vehicle UE often moves at high speed, which may increase the handover (HO) interruption time and/or the failure risk, and badly impact the V2X service performance.

The present disclosure proposes a solution of mobility optimization, which may enable a communication network to perform (earlier) HO preparation for terminal devices with similar mobility behavior by use of sidelink, so as to achieve better robustness of communication and user experience by improving HO performance of the terminal devices such as sidelink capable UEs.

According to a first aspect of the present disclosure, there is provided a method implemented at a first terminal device. The method comprises identifying a second terminal device having mobility behavior similarity to the first terminal device. The mobility behavior similarity indicates that a difference in mobility behavior between the first terminal device and the second terminal device is within a predefined range. The method further comprises transmitting similarity signaling which indicates the mobility behavior similarity to a network node serving the first terminal device.

In accordance with some exemplary embodiments, the identification of the second terminal device may be based at least in part on a message received by the first terminal device and indicating the mobility behavior of the second terminal device.

In accordance with some exemplary embodiments, the message indicating the mobility behavior of the second terminal device may comprise at least one of: a broadcast message from the second terminal device; a multicast message within a service group comprising at least the first terminal device and the second terminal device; and a discovery message for a service group comprising at least the first terminal device and the second terminal device.

In accordance with some exemplary embodiments, the mobility behavior may be represented by at least one of: a position, a moving path, a moving direction, and an associated service group.

In accordance with some exemplary embodiments, the similarity signaling may include an identifier of the second terminal device. According to an exemplary embodiment, the identifier of the second terminal device may comprise at least one of a sidelink identifier and a radio network identifier of the second terminal device.

In accordance with some exemplary embodiments, the method according to the first aspect of the present disclosure may further comprise reporting a sidelink identifier of the first terminal device to the network node.

In accordance with some exemplary embodiments, the method according to the first aspect of the present disclosure may further comprise obtaining a radio network identifier of the second terminal device over a sidelink between the first terminal device and the second terminal device.

In accordance with some exemplary embodiments, the method according to the first aspect of the present disclosure may further comprise obtaining radio resource control (RRC) status of the second terminal device over a sidelink between the first terminal device and the second terminal device.

In accordance with some exemplary embodiments, the radio network identifier of the second terminal device may be obtained in a message containing a sidelink identifier of the second terminal device.

In accordance with some exemplary embodiments, the method according to the first aspect of the present disclosure may further comprise informing a radio network identifier of the first terminal device to the second terminal device over a sidelink between the first terminal device and the second terminal device.

In accordance with some exemplary embodiments, the method according to the first aspect of the present disclosure may further comprise informing RRC status of the first terminal device to the second terminal device over a sidelink between the first terminal device and the second terminal device.

In accordance with some exemplary embodiments, the transmission of the similarity signaling to the network node may be triggered by an event that signal quality measured by the first terminal device with respect to the network node is lower than a predefined threshold.

In accordance with some exemplary embodiments, the method according to the first aspect of the present disclosure may further comprise announcing that the similarity signaling is transmitted to the network node by the first terminal device, so as to prevent the second terminal device from transmitting, to the network node, similarity signaling indicating the mobility behavior similarity.

In accordance with some exemplary embodiments, the method according to the first aspect of the present disclosure may further comprise suspending the transmission of the similarity signaling to the network node for a configurable period of time, in response to an announcement that the second terminal device transmits, to the network node, similarity signaling indicating the mobility behavior similarity.

In accordance with some exemplary embodiments, the second terminal device may be served by the network node and can transmit a sidelink identifier of the second terminal device to the network node. Optionally, the second terminal device may be operated in a radio connected mode.

In accordance with some exemplary embodiments, the similarity signaling transmitted by the first terminal device may further indicate at least one of: a radio resource control status of the second terminal device; a position of the second terminal device; a distance between the first terminal device and the second terminal device; and an identifier of a network node serving the second terminal device.

In accordance with some exemplary embodiments, the similarity signaling transmitted from the first terminal device to the network node may be used by the network node to determine whether to perform handover preparation for the first terminal device.

According to a second aspect of the present disclosure, there is provided an apparatus. The apparatus may comprise one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus. The apparatus may comprise an identifying unit and a transmitting unit. In accordance with some exemplary embodiments, the identifying unit may be operable to carry out at least the identifying step of the method according to the first aspect of the present disclosure. The transmitting unit may be operable to carry out at least the transmitting step of the method according to the first aspect of the present disclosure.

According to a fifth aspect of the present disclosure, there is provided a method implemented at a network node. The method comprises receiving, from a first terminal device being served by the network node, similarity signaling to indicate that the first terminal device has mobility behavior similarity to a second terminal device. The mobility behavior similarity indicates that a difference in mobility behavior between the first terminal device and the second terminal device is within a predefined range. In some embodiments, the method may further comprise determining whether to perform handover preparation for the second terminal device, based at least in part on the similarity signaling.

In accordance with some exemplary embodiments, the similarity signaling may include an identifier of the second terminal device. Optionally, the identifier of the second terminal device may comprise a sidelink identifier and/or a radio network identifier of the second terminal device.

In accordance with some exemplary embodiments, the method according to the fifth aspect of the present disclosure may further comprise: receiving a sidelink identifier of the first terminal device from the first terminal device; and determining a mapping relationship between the sidelink identifier and a radio network identifier of the first terminal device.

In accordance with some exemplary embodiments, the method according to the fifth aspect of the present disclosure may further comprise: receiving a sidelink identifier of the second terminal device from the second terminal device which is served by the network node, and determining a mapping relationship between the sidelink identifier and a radio network identifier of the second terminal device.

In accordance with some exemplary embodiments, the method according to the fifth aspect of the present disclosure may further comprise: forwarding at least one of the received sidelink identifiers to other network node.

In accordance with some exemplary embodiments, the second terminal device may be served by the network node and the network node can determine to perform the handover preparation for the second terminal device.

In accordance with some exemplary embodiments, the method according to the fifth aspect of the present disclosure may further comprise: selecting one or more candidate network nodes to perform the handover preparation, according to at least one of measurement reports of the first terminal device and the second terminal device.

In accordance with some exemplary embodiments, the selection of the one or more candidate network nodes may also be performed based at least in part on a service configuration of at least one of the first terminal device and the second terminal device.

In accordance with some exemplary embodiments, the second terminal device may be served by another network node and the network node can determine not to perform the handover preparation for the second terminal device.

In accordance with some exemplary embodiments, the method according to the fifth aspect of the present disclosure may further comprise: informing said another network node to perform the handover preparation for the second terminal device.

In accordance with some exemplary embodiments, the similarity signaling received from the first terminal device may further indicate at least one of: a radio resource control status of the second terminal device; a position of the second terminal device; a distance between the first terminal device and the second terminal device; and an identifier of a network node serving the second terminal device.

In accordance with some exemplary embodiments, the similarity signaling may be used by the network node to determine whether to perform handover preparation for the first terminal device.

According to a sixth aspect of the present disclosure, there is provided an apparatus. The apparatus may comprise one or more processors and one or more memories comprising computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus. The apparatus may comprise a receiving unit and optionally, a determining unit. In accordance with some exemplary embodiments, the receiving unit may be operable to carry out at least the receiving step of the method according to the fifth aspect of the present disclosure. The determining unit may be operable to carry out at least the determining step of the method according to the fifth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating exemplary V2X scenarios for an LTE-based network (NW) according to an embodiment of the present disclosure;

FIG. 2 is a diagram illustrating an exemplary HO procedure according to an embodiment of the present disclosure;

FIG. 3 is a diagram illustrating an example of HO preparation by use of sidelink according to an embodiment of the present disclosure;

FIG. 4 is a flowchart illustrating a method according to some embodiments of the present disclosure;

FIG. 5 is a flowchart illustrating another method according to some embodiments of the present disclosure;

FIG. 6 is a block diagram illustrating an apparatus according to some embodiments of the present disclosure;

FIG. 7 is a block diagram illustrating another apparatus according to some embodiments of the present disclosure;

FIG. 8 is a block diagram illustrating yet another apparatus according to some embodiments of the present disclosure;

FIG. 9 is a block diagram illustrating a telecommunication network connected via an intermediate network to a host computer in accordance with some embodiments of the present disclosure;

FIG. 10 is a block diagram illustrating a host computer communicating via a base station with a UE over a partially wireless connection in accordance with some embodiments of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure;

FIG. 13 is a flowchart illustrating a method implemented in a communication system, in accordance with an embodiment of the present disclosure; and

FIG. 14 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow V2X communications to be implemented in a wireless communication network such as 4G/LTE or 5G/NR network. V2X communications may carry both non-safety and safety information, where each of the applications and services related to V2X communications may be associated with specific requirements sets, e.g., in terms of latency, reliability, data rates etc.

V2X communications may take advantage of a network (NW) infrastructure, when available, but at least basic V2X connectivity needs to be possible even in case of lack of coverage. Many use cases may be defined for V2X communications, for example, vehicle-to-vehicle (V2V) communication, vehicle-to-pedestrian (V2P) communication, and vehicle-to-infrastructure/network (V2I/N) communication. Providing an LTE-based V2X interface may be economically advantageous because of the LTE economies of scale and it may enable tighter integration between communications with the NW infrastructure (V2I), pedestrian (V2P) and other vehicles (V2V), as compared to using a dedicated V2X technology. Direct unicast (i.e. one-to-one) and/or multicast (i.e. one-to-many) transmissions over sidelink may be needed in some use cases such as platooning, cooperative driving, dynamic ride sharing, etc. Some advanced applications of V2X communications may have more stringent requirements on the needed data rate, capacity, reliability, latency, communication range and speed.

In accordance with some exemplary embodiments, the V2V communication may cover LTE-based communication between vehicles, for example, via Uu or sidelink (PC5) interface. Specifically, the V2P communication may cover LTE-based communication between a vehicle and a device carried by an individual (e.g. handheld terminal carried by a pedestrian, cyclist, driver or passenger), for example, via Uu or sidelink (PC5) interface. The V2I/N communication may cover LTE-based communication between a vehicle and a roadside unit/network. A roadside unit (RSU) may be a transportation infrastructure entity (e.g. an entity transmitting speed notifications) that communicates with V2X capable UEs over sidelink (PC5) interface. For V2N, the communication may be performed on Uu interface.

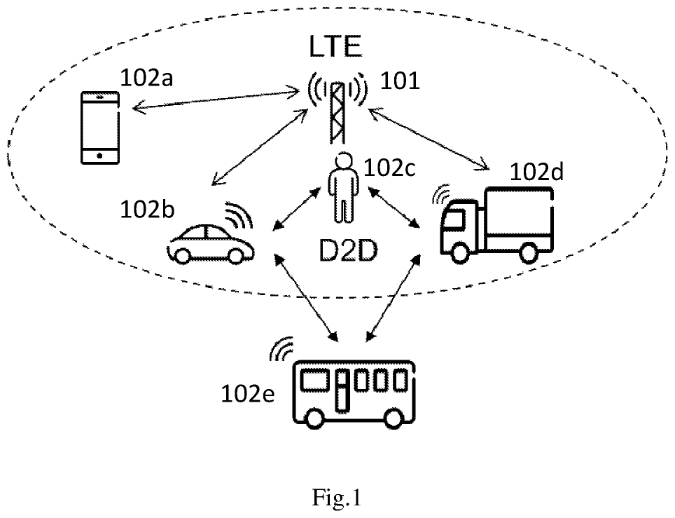

FIG. 1 is a diagram illustrating exemplary V2X scenarios for an LTE-based network (NW) according to an embodiment of the present disclosure. Various embodiments of the present disclosure are described without limitation in the context of a communication system as illustrated in the diagram of FIG. 1. The communication system may include UEs that are configured for D2D, V2X, and/or other sidelink communications in accordance with various embodiments of the present disclosure. As shown in FIG. 1, the communication system can include a network node 101 (e.g., an eNB), and a plurality of UEs 102a-102e. The UEs 102a-102e can be any type of electronic device or wireless communication device configured for D2D and/or V2X communications such as V2I, V2P, V2V communications or any combination thereof. As used herein, D2D is referred to in a broader sense to include communications between any type of UEs, and includes V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

Although various embodiments are explained in the context of V2X communications, some embodiments can also be used for other types of direct communications, including D2D and other sidelink communications. Accordingly, the term “V2X” herein can be replaced with the term “D2D” for some exemplary embodiments. Moreover, although some embodiments are described in the context of LTE evolution, they may be used in other wireless systems, including systems that operate according to 5G standards, also referred to as NR, or future radio technologies and standards.

The V2X device can be aware of other device(s) in its neighborhood area as well as their positions, speed (e.g., both velocity and direction), basic attributes and basic sensor information, for example, by receiving cooperative awareness messages (CAMs). Information distributed by CAM is commonly used by some services (e.g. safety related services such as approaching emergency vehicle, slow vehicle warning, etc.). At receiver side, reasonable efforts can be taken to evaluate the relevance of the messages and the information. This allows the device to get information about its situation and act accordingly.

In accordance with some exemplary embodiments, sidelink data transmission can be carried by a sidelink shared channel (SL-SCH). Currently the SL-SCH medium access control (MAC) header is of variable size and consists of the following fields:
V: The MAC packet data unit (PDU) format version number field indicates which version of the SL-SCH subheader is used.
SRC: The source layer-2 identifier (ID) field carries the identity of the source. It is set to the ProSe UE ID. The SRC field size is 24 bits.
DST: The DST field can comprise 16 bits or 24 bits. If it comprises 16 bits, it carries the 16 most significant bits of the destination layer-2 ID. If it comprises 24 bits, it is set to the destination layer-2 ID.
LCID: The logical channel ID field uniquely identifies the logical channel instance within the scope of one source layer-2 ID and destination layer-2 ID pair of the corresponding MAC SDU.
L: The length field indicates the length of the corresponding MAC SDU in bytes.
F: The format field indicates the size of the length field.
E: The extension field is a flag indicating if more fields are present in the MAC header or not.
R: Reserved bit, which is set to “0”.

A sidelink capable UE can indicate the destination layer-2 ID(s) for relay or non-relay related one-to-one or one-to-many sidelink communication and also the destination layer-2 ID(s) for the (broadcasted) V2X sidelink communication via SidelinkUEInformation to the NW. For one-to-one sidelink communication, the destination layer-2 ID is identified by the ProSe UE ID for unicast communication, while for one-to-many sidelink communication the destination layer-2 ID is identified by the ProSe layer-2 group ID.

Proximity services (ProSe) direct discovery is a process that detects and identifies another UE in proximity After being discovered, the UEs can establish direct communication over sidelink. Discovery and link establishment are needed if the UEs want to have direct communication using unicast or multicast. A ProSe UE ID may be included in the discovery announcement message and the discovery response message, which can later be used as source layer-2 ID and/or destination layer-2 ID during the direct communication. For V2X sidelink communication using broadcast, discovery and link establishment may not be needed, and the destination layer-2 ID can be set to the identifier provided by upper layers.

In addition to V2X communications, a sidelink capable UE can also maintain its connection with a cellular communication system. Due to the mobility of a UE, a handover (HO) procedure may be performed to transfer an ongoing connection of the UE from one base station (i.e. the serving base station) to another base station (i.e. the target base station), or from one cell to another within the same base station. The HO procedure may include a preparation phase, an execution phase and a completion phase.

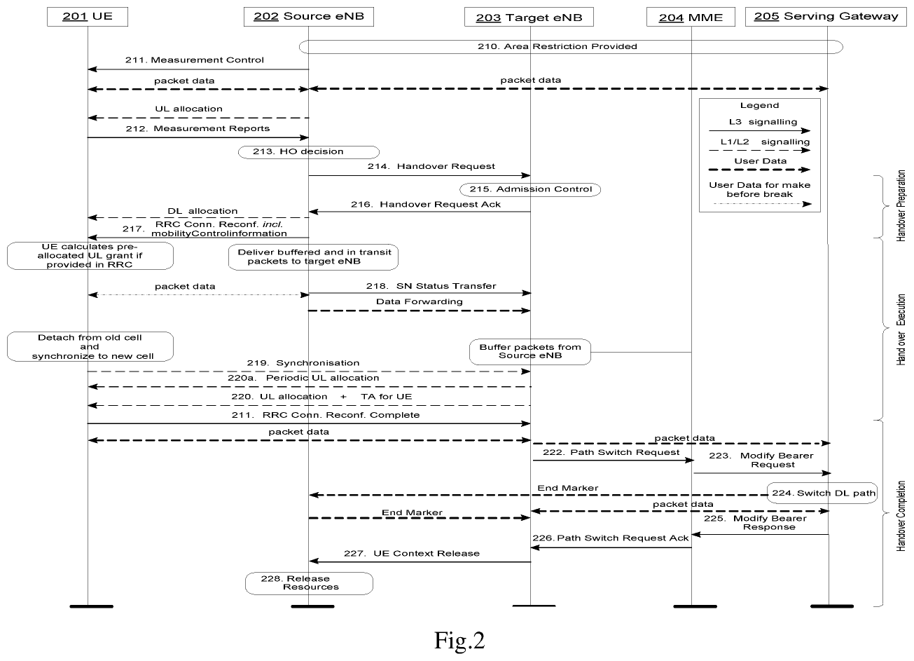

FIG. 2 is a diagram illustrating an exemplary HO procedure according to an embodiment of the present disclosure. For simplicity, FIG. 2 only depicts some exemplary network elements such as a UE 201, a source eNB 202, a target eNB 203, a mobility management entity (MME) 204, and a serving gateway 205. It can be recognized that signaling messages and network elements shown in FIG. 2 are just as examples, and more or less alternative signaling messages and network elements may be involved in the HO procedure according to the embodiments of the present disclosure. The exemplary HO procedure shown in FIG. 2 may be applicable to the intra-MME/serving gateway HO in an LTE scenario where neither MME nor serving gateway changes. For example, some area restriction may be provided as shown in step 210. It will be appreciated that there may be other scenarios where the communication network may apply or support various mobility management schemes and/or radio interface technologies which are not limited to LTE.

According to the procedure as illustrated in FIG. 2, the source eNB 202 can provide measurement configuration to the UE 201 (step 211). The measurement configuration can control the UE 201 to make signal measurement. Some packet data may be communicated between the UE 201 and the source eNB 202, and between the source eNB 202 and the serving gateway 205. The source eNB 202 can make uplink (UL) allocation for the UE 201. When a measurement report is triggered, the UE 201 can send the measurement report to the source eNB 202 (step 212), which may include the quality measurement of both source cell and candidate cell(s). The source eNB 202 can make a HO decision based on the measurement report (step 213) and send a HO request message to the target eNB 203 (step 214), where the HO preparation starts.

The HO request message from the source eNB 202 to the target eNB 203 may include the global ID of the target cell (of the target eNB 203), the UE's quality of service (QoS)/bearer configuration and security configuration, etc. The target eNB 203 may perform admission control dependent on the received QoS information (step 215). If admitted, the target eNB 203 sends the HO request acknowledgement (ACK) to the source eNB 202 (step 216), then the source eNB 202 sends a HO command to the UE 201 (e.g., RRCConnectionReconfiguration message including the mobilityControlInformation), where the HO execution starts (step 217). On the other hand, the source eNB 202 can make downlink (DL) allocation for the UE 201, and deliver buffered and in transit packets to the target eNB 203. The UE 201 can calculate pre-allocated UL grant if provided in RRC, and optionally communicate some packet data with the source eNB 202.

During the HO execution phase, the source eNB 202 may send the packet data convergence protocol (PDCP) sequence number (SN) status to the target eNB 203 to ensure lossless HO (step 218). Some packet data may also be forwarded from the source eNB 202 to the target eNB 203 where the packet data can be buffered. For the UE 201, it may need to detach from the old cell and synchronize to the new cell. In step 219 and step 220a/220, the UE 201 can perform synchronization and establish L1/L2 connection with the target cell (of the target eNB 203). For example, the UE 201 can get the periodic UL allocation from the target eNB 203. Optionally, the target eNB 203 can configure UL allocation and timing advance (TA) for the UE 201.

When the synchronization and connection establishment of the UE 201 are succeeded, an RRCConnectionReconfiguration-Complete message is sent to the target eNB 203 to confirm the HO (step 221). At this step, the HO completion phase starts. This phase can setup the data bearer between the UE 201 and the serving gateway 205 via the target eNB 203, and then release the UE context in the old source eNB 202, as shown from step 222 to step 228. For example, during the HO completion phase, the target eNB 203 can send a path switch request to the MME 204. In response to a modify bearer request from the MME 204, the serving gateway 205 switches the DL path and sends a modify bearer response to the MME 204. The target eNB may receive a pach switch request ACK from the MME 204 and then send a UE context release message to the source eNB 202 to release relevant resources.

The UE served by a communication network may comprise a high-speed vehicle UE. Rapid movement of the vehicle UE may affect its communication performance due to the increased HO interruption time and/or link failure. On the other hand, a break of safety services (e.g. platooning, remote driving, etc.) can lead to severe traffic accident which needs to be avoided as much as possible. In some cases where several vehicles move in vicinity and may have similar speed (e.g., direction or also velocity), mobility behavior of these vehicles may be utilized to facilitate the HO decision, so as to improve HO performance of the vehicle UEs.

In the proposed solution according to some exemplary embodiments, HO preparation for UEs with similar mobility behavior can be performed earlier by use of sidelink. According to some exemplary embodiments, a UE such as a vehicle UE can identify whether there are other UEs have similar mobility behavior to it. For example, if the UEs move in vicinity and in the same road/direction (which may be learn from the information obtained from CAM transmitted over sidelink), or if the UEs are in the same V2X service group, these UEs may have similar mobility behavior. In accordance with some exemplary embodiments, the UE can retrieve the IDs of the identified UEs over sidelink. The ID may be the sidelink (layer 2) ID or the ID used for Uu interface (e.g. cell-radio network temporary identifier (C-RNTI)). The IDs of the identified UEs can be included in HO similarity signaling sent by the UE to the NW. Optionally, the UEs may exchange their Uu IDs over sidelink. Alternatively or additionally, the UEs may report their sidelink (layer-2) IDs to the NW. The similarity signaling from the sending UE may only include the UEs that are served by the same cell/node to the sending UE. According to the similarity signaling, the NW can perform (earlier) HO preparation for the identified UEs and optionally also the UE sending the HO similarity signaling. By using the proposed solution, the HO interruption time and/or the failure probability could be reduced, which improves the performance of the (ongoing) services. This is especially important for safety related services. Although in the present disclosure, the similarity signaling is used for the handover scenario, a person skilled in the art shall understand that this signaling or the information included in this signaling may also be used for other applications, e.g. QoS prediction, proactive resource reservation, Inter-cell coordination for support a group application, etc.

It is noted that some embodiments of the present disclosure are mainly described in relation to 4G or LTE specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

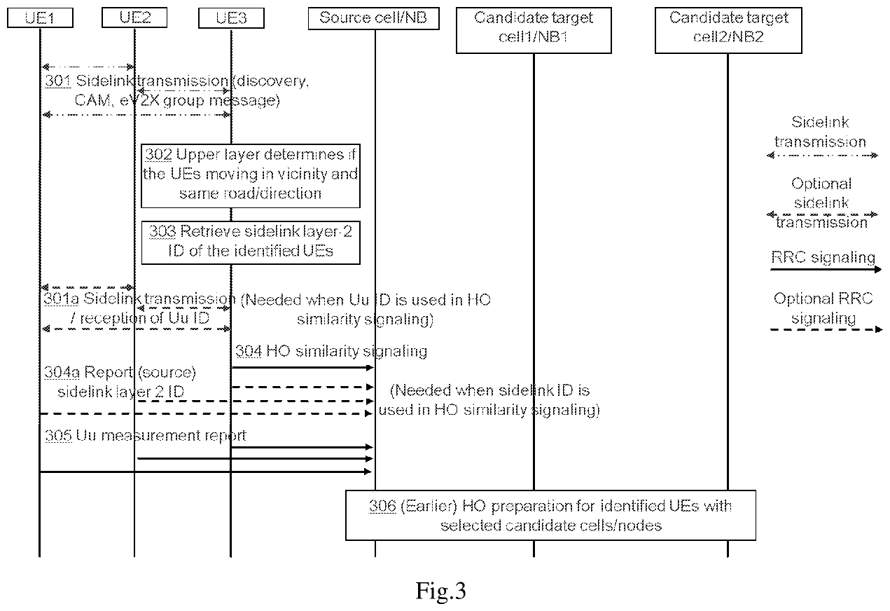

FIG. 3 is a diagram illustrating an example of HO preparation by use of sidelink according to an embodiment of the present disclosure. For simplicity, FIG. 3 only depicts some exemplary network elements such as UE1, UE2, UE3, a source cell/NB, candidate target cell1/NB1, and candidate target cell2/NB2. It can be recognized that signaling messages and network elements shown in FIG. 3 are just as examples, and more or less alternative signaling messages and network elements may be involved in the HO preparation according to the embodiments of the present disclosure. The exemplary HO preparation shown in FIG. 3 may be applicable in a network scenario where a UE (such as UE1, UE2 and UE3) can be configured to support sidelink communication. In this embodiment, the UE such as a vehicle UE can inform the NW that some other (vehicle) UEs may have similar HO behavior, e.g. having the same (candidate) target cell(s) and optionally also the same serving cell. The NW then can perform HO preparation earlier for those UEs with similar HO behavior. In this way, the HO interruption time and/or the failure probability can be reduced.

In accordance with some exemplary embodiments, UEs such as vehicle UEs may have similar HO behavior if they have similar mobility behavior (e.g., moving in vicinity and/or in the same road/direction). The upper layer (e.g. the application layer) of a UE (such as UE3) can identify such mobility behavior similarity, for example, according to one or more messages received (e.g. periodically) from other UEs (such as UE1 and UE2) through sidelink transmission (step 301). By checking the received message (e.g. discovery message, broadcasted CAM, eV2X group message, beacon, or any type of message containing a set of information such as position, lane position, moving direction, moving speed, etc.), UE3 can determine if other UEs are moving in vicinity and in the same road/direction (step 302). The upper layer of UE3 can inform its lower layer (e.g. the access stratum (AS) layer) whether another UE sending the CAM is in vicinity and moving in the same road/direction. The AS layer of UE3 can retrieve the (source) sidelink layer-2 ID of the nearby UE from the MAC header of SL-SCH that carries e.g. the CAM (step 303). It can be appreciated that UE1 and/or UE2 can also identify those UE(s) with similar mobility behavior and retrieve the sidelink layer-2 ID of the identified UE(s).

According to an exemplary embodiment where UE1, UE2 and UE3 are vehicle UEs in the same V2X service group (e.g. platooning), UE1, UE2 and UE3 may move close to each other, in the same road and with similar speed (e.g., both velocity and direction). In this case, UE1/UE2/UE3 can know whether another UE has similar mobility/HO behavior by checking if they are in the same V2X service group. The UE (e.g., the AS layer) can directly know whether another UE is in the same V2X service group, for example, from the source layer-2 ID and the destination layer-2 group ID in the MAC header of SL-SCH carrying the message multicast within the V2X service group, or from the ProSe layer-2 ID and the ProSe layer-2 group ID carried in the discovery announcement/response messages for the V2X service group.

After the identification of other UEs with similar mobility behavior, UE3 (e.g., the AS layer) can inform the NW that some other UEs have similar HO behavior to UE3, for example, by sending an RRC signaling (which is denoted by the HO similarity signaling in step 304 of FIG. 3) to the source cell/NB. The UE may only send the HO similarity signaling to the source cell/NB when the measured quality to its serving cell/node is lower than a predefined threshold. Optionally, only specific UE(s) may be allowed to send the HO similarity signaling to the NW, for example, the UE which is leading a certain group (e.g. platoon), or a subset of UEs belonging to a certain group, where the subset may be made up of UEs which are spaced within a certain distance (e.g. at most L meters apart), or which are placed in certain positions in the group, or which have better radio conditions with respect to the serving cell/node.

In accordance with some exemplary embodiments, the HO similarity signaling may include the ID of each UE identified by UE3. For example, the ID may comprise a sidelink layer-2 ID, which can be known from the (source) layer-2 ID in the MAC header of the SL-SCH carrying the CAM or the message multicast within the V2X service group, or from ProSe layer-2 ID contained in the relevant discovery message. In order for the NW (e.g. the source cell/NB) to identify the relevant UEs over Uu interface, the sidelink capable UE (such as UE1, UE2 and UE3) can optionally report its sidelink layer-2 ID (e.g., in SidelinkUEInformation) to the serving cell/node (step 304a). The serving cell/node (e.g., the source cell/NB in FIG. 3) can store the mapping between the sidelink layer-2 ID and the Uu ID (e.g. C-RNTI) used for Uu interface, and later on retrieve the Uu ID to use based on the reported sidelink layer-2 ID. FIG. 3 only shows an exemplary situation where UE1, UE2 and UE3 are served by the same cell/node (i.e., the source cell/NB in FIG. 3). It can be appreciated that UE1, UE2 and UE3 being served by different cells/nodes is also possible. For example, in the case that UE1 is not served by the source cell/NB of UE3, UE1 can report its sidelink layer-2 ID to the corresponding serving cell/node.

Optionally, the serving cell/node may forward the received sidelink layer-2 ID of the reporting UE to an upper node, for example, an MME or an access and mobility management function (AMF). The upper node can store the mapping between the sidelink layer-2 ID, the Uu ID, and the serving cell/node of the UE. In the case that UE1 not being served by the source cell/NB is indicated in the HO similarity signaling from UE3, the source cell/NB can inform the upper node that HO preparation for UE1 may need to be performed by another cell/NB which is currently serving UE1.

Alternatively or additionally, the UE ID included in the HO similarity signaling may comprise an ID used for Uu interface, e.g. C-RNTI of the UE. In order to make the UE to know the Uu IDs of other UEs, each sidelink capable UE can announce its Uu ID over sidelink. For example, UE1/UE2/UE3 can optionally include its Uu ID in the CAM, or the (e)V2X data/discovery message for a certain V2X service group (step 301a). Alternatively, UE1/UE2/UE3 can use a new specific message (e.g., a control message) for carrying the Uu ID. Optionally, the new message may also include a sidelink application layer or AS layer ID of the UE sending this message, so that the UE receiving the message can know which sidelink ID the Uu ID corresponds to.

In accordance with some exemplary embodiments, UE3 may only include IDs of the connected mode UEs in the HO similarity signaling, or explicitly indicate the UE RRC status in the HO similarity signaling, considering that HO is usually performed for UEs in RRC connected mode. In this case, UE1 and UE2 may indicate their RRC status over sidelink, so that UE3 can determine whether and how to inform the IDs of UE2 and UE1 to the source cell/NB. Alternatively, UE1/UE2 which is in RRC idle/inactive mode may not indicate its Uu ID to UE3. As such, UE3 may only indicate the sidelink layer-2 ID of UE1/UE2 in the HO similarity signaling, and if the source cell/NB has no information about the mapping between the sidelink layer-2 ID and the Uu ID, the source cell/NB may not be able to identify the relevant UE over Uu interface and will not perform HO preparation for UE1/UE2.

Optionally, the HO similarity signaling may also include the position of the identified UEs, either explicitly or implicitly. For example, the order in which the identified UE is included in the HO similarity signaling may represent the order in terms of how far the identified UE is from the UE sending the HO similarity signaling to the NW.

According to the signaling information from the sending UE such as UE3, the NW (e.g. the source cell/NB) can perform (earlier) HO preparation for those UEs with similar HO behavior to the sending UE. Optionally, the (earlier) HO preparation may also be performed for the sending UE. The candidate cells/nodes for the (earlier) HO preparation can be selected based on a measurement report (e.g., the latest Uu measurement report in step 305) from the sending UE which sends the HO similarity signaling, and/or based on a measurement report (e.g., the latest Uu measurement report in step 305) from (any of) the UEs with similar HO behavior to the sending UE.

In accordance with some exemplary embodiments, the (earlier) HO preparation for each relevant UE may be triggered, for example, when the measured quality to the corresponding serving cell/node is lower than a predefined threshold. The NW can determine for each relevant UE the candidate target cells/nodes (such as candidate target cell1/NB1 and candidate target cell2/NB2) to perform (earlier) HO preparation (step 306), for example, based at least in part on the measured quality the UE's QoS configuration/requirement, the network load, and etc. Then HO execution may be performed for each relevant UE with respect to one cell/node selected from the determined candidate target cells/nodes.

In an exemplary embodiment where a sidelink layer-2 ID of a UE is indicated in the HO similarity signaling, the source cell/NB needs to determine whether it is the serving cell/node of this UE. For example, if the source cell/NB receives (or has received) the sidelink layer-2 ID of the UE, for example, via SidelinkUE-Information and holds this sidelink layer-2 ID, it means that the UE is currently served by the source cell/NB. It can be appreciated that the reception of the sidelink layer-2 ID from the corresponding UE may happen either before or after the reception of the HO similarity signaling by the serving cell/node.

Optionally, the source cell/NB may inform the upper node (e.g. MME or AMF) of the sidelink layer-2 ID of a UE which is not served by the source cell/NB. The upper node then, based on the stored mapping between the sidelink layer-2 ID, the Uu ID and the serving cell/node, can inform the sidelink layer-2 ID or the Uu ID of the UE to the corresponding serving cell/node and indicate the need of an (earlier) HO preparation. With such inter-cell coordination, the corresponding serving cell/node may then trigger and perform the (earlier) HO preparation for the UE.

In an exemplary embodiment where the Uu ID (e.g. C-RNTI) is indicated in the HO similarity signaling, the sending UE of the HO similarity signaling may be responsible to ensure that only UE(s) served by the same cell/node as the sending UE are included in the HO similarity signaling. To realize this, the sidelink capable UE may inform its serving cell/node ID (e.g., the physical cell/node ID or the global cell/node ID) over sidelink. Optionally, the sidelink capable UE may indicate its serving cell/node ID in the announcement of Uu ID over sidelink as shown in step 301a. Thus, the sending UE can indicate (e.g. by using one bit) those UEs which have similar mobility/HO behavior and are served by the same cell/node as the sending UE in the HO similarity signaling to the NW.

In accordance with some exemplary embodiments, various kinds of identifier information may be indicated in the HO similarity signaling to facilitate the implementation of HO preparation. Optionally, the serving cell/node ID of each UE identified by the sending UE (such as UE3) may be included in the HO similarity signaling. Based on the serving cell/node ID, the source cell/NB can know whether the relevant UE is served by it or not. For the UE which is not served by the source cell/NB, the Uu ID of this UE and the need of (earlier) HO preparation may be informed to the corresponding serving cell/node by the source cell/NB.

In accordance with some exemplary embodiments, the sending UE such as UE3 may announce over sidelink that the HO similarity signaling has been or will be sent to the NW. Optionally, the sending UE may also announce the corresponding serving cell ID and the ID of each UE which is included in the HO similarity signaling. As such, the UE receiving the announcement may not need to send the same HO similarity signaling again, or can suspend the sending of the HO similarity signaling for a certain configurable period of time, for example, unless the receiving UE changes its serving cell/node. Alternatively or additionally, it may be configured or coordinated in prior that which UE is responsible for sending the HO similarity signaling (which is more feasible for a service group).

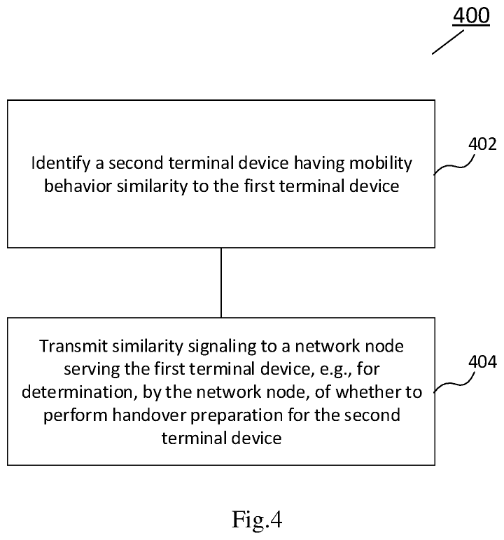

FIG. 4 is a flowchart illustrating a method 400 according to some embodiments of the present disclosure. The method 400 illustrated in FIG. 4 may be performed by an apparatus implemented in a terminal device or communicatively coupled to a terminal device. In accordance with an exemplary embodiment, the terminal device such as UE may be configured to communicate with a network node such as a base station and support V2X or sidelink communication. In accordance with some exemplary embodiments, the terminal device (which is also known as a first terminal device) can obtain mobility related information of another terminal device (which is also known as a second terminal device) over sidelink, and inform the network node of mobility/HO behavior similarity of the second terminal device to the first terminal device. It will be appreciated that the second terminal device also can perform the method 400 as illustrated in FIG. 4, although the method 400 will be described hereafter with respect to the first terminal device.

According to the exemplary method 400 illustrated in FIG. 4, the first terminal device (such as UE3 shown in FIG. 3) can identify a second terminal device (such as UE1 or UE2 shown in FIG. 3) having mobility behavior similarity to the first terminal device, as shown in block 402. In accordance with some exemplary embodiments, the mobility behavior similarity may indicate that a difference in mobility behavior between the first terminal device and the second terminal device is within a predefined range. The mobility behavior may be represented by at least one of a position, a moving path, a moving direction, and an associated service group. Therefore, the second terminal device having the mobility behavior similarity to the first terminal device may imply that the first terminal device and the second terminal device move in vicinity, have similar speed, and/or are members of the same service group.

In accordance with some exemplary embodiments, the identification of the second terminal device may be based at least in part on a message received by the first terminal device and indicating the mobility behavior of the second terminal device. The message indicating the mobility behavior of the second terminal device may comprise at least one of: a broadcast message (e.g., CAM) from the second terminal device; a multicast message within a service group comprising at least the first terminal device and the second terminal device; and a discovery message for a service group comprising at least the first terminal device and the second terminal device. Optionally, the first terminal device can obtain a sidelink identifier of the second terminal device from the message indicating the mobility behavior of the second terminal device and/or from signaling information (e.g., the MAC header of SL-SCH) associated with this message.

According to the exemplary method 400 illustrated in FIG. 4, the first terminal device can transmit similarity signaling (such as HO similarity signaling shown in step 304 of FIG. 3) to a network node (such as the source cell/NB shown in FIG. 3) serving the first terminal device, e.g. for determination, by the network node, of whether to perform handover preparation for the second terminal device, as shown in block 404. Optionally, the similarity signaling may also be used by the network node to determine whether to perform handover preparation for the first terminal device. The similarity signaling can indicate the mobility behavior similarity between the first terminal device and the second terminal device. Optionally, mobility behavior similarity between the first terminal device and one or more other terminal devices also may be indicated by the similarity signaling. In accordance with some exemplary embodiments, the transmission of the similarity signaling to the network node may be triggered by an event that signal quality measured by the first terminal device with respect to the network node is lower than a predefined threshold. Optionally, the first terminal device may be designated as a representative of at least the second terminal device to transmit the similarity signaling to the network node.

According to some exemplary embodiments, the similarity signaling may include an identifier of the second terminal device. The identifier of the second terminal device may comprise at least one of a sidelink identifier (e.g., sidelink layer-2 ID) and a radio network identifier (e.g., Uu ID such as C-RNTI) of the second terminal device. In accordance with some exemplary embodiments, the first terminal device can obtain RRC status, the sidelink identifier and/or the radio network identifier of the second terminal device over a sidelink between the first terminal device and the second terminal device. For example, the radio network identifier of the second terminal device may be obtained in a message such as CAM, a discovery or multicast message for a service group, or any proper message containing the sidelink identifier of the second terminal device. Alternatively, the first terminal device can get the radio network identifier and the sidelink identifier of the second terminal device in different messages.

In accordance with some exemplary embodiments, the first terminal device can inform its RRC status, radio network identifier and/or sidelink identifier to the second terminal device over a sidelink between the first terminal device and the second terminal device. As such, the second terminal device can include the RRC status, the radio network identifier and/or the sidelink identifier of the first terminal device in similarity signaling transmitted by the second terminal device to its serving network node. Optionally, the first terminal device may report its sidelink identifier to the network node. In the case that the second terminal device is served by the network node, the second terminal device may transmit its sidelink identifier to the network node.

In accordance with some exemplary embodiments, the first terminal device can announce that the similarity signaling is transmitted to the network node by the first terminal device, so as to prevent the second terminal device from transmitting, to the network node, similarity signaling indicating the mobility behavior similarity. In the case that another terminal device such as the second terminal device is configured as a representative of a service group including at least the first and second terminal devices to send similarity signaling to the network node, the first terminal device may not perform the transmission of the similarity signaling to the network node. According to an exemplary embodiment, the first terminal device may suspend the transmission of the similarity signaling to the network node for a configurable period of time, in response to an announcement that the second terminal device transmits, to the network node, similarity signaling indicating the mobility behavior similarity.

In accordance with some exemplary embodiments, the similarity signaling transmitted by the first terminal device to the network node may further indicate at least one of: a radio resource control (RRC) status of the second terminal device; a position of the second terminal device; a distance between the first terminal device and the second terminal device; and an identifier of a network node serving the second terminal device. Optionally, the second terminal device is operated in a radio connected mode (e.g., RRC connected mode), so that the terminal device(s) indicated in the HO similarity signaling and potentially requiring HO preparation may not be in the RRC idle/inactive mode.

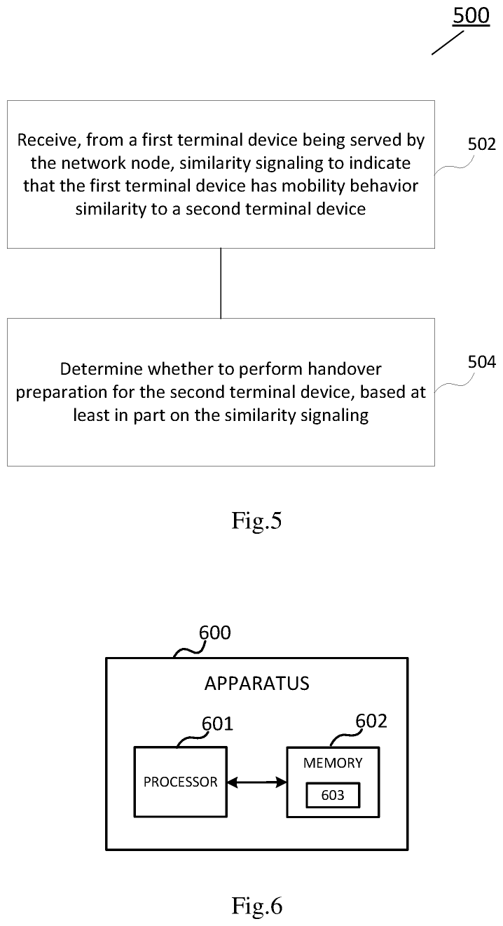

FIG. 5 is a flowchart illustrating a method 500 according to some embodiments of the present disclosure. The method 500 illustrated in FIG. 5 may be performed by an apparatus implemented in a network node or communicatively coupled to a network node. In accordance with an exemplary embodiment, the network node may comprise a base station such as eNB/gNB. The network node can be configured to communicate with one or more terminal devices such as UEs which may be able to support sidelink communication.

According to the exemplary method 500 illustrated in FIG. 5, the network node can receive, from a first terminal device being served by the network node, similarity signaling to indicate that the first terminal device has mobility behavior similarity to a second terminal device, as shown in block 502. In accordance with some exemplary embodiments, the mobility behavior similarity may indicate that a difference in mobility behavior between the first terminal device and the second terminal device is within a predefined range. As described in connection with FIG. 4, the first terminal device may have a similar position, moving path, moving direction, and/or the same service group with the second terminal device. Optionally, the network node may be aware of mobility behavior similarity between the first terminal device and one or more other terminal devices according to the similarity signaling.

In accordance with some exemplary embodiments, the similarity signaling received by the network node may include a sidelink identifier and/or a radio network identifier of the second terminal device. Optionally, the network node may receive a sidelink identifier of the first terminal device from the first terminal device. A mapping relationship between the received sidelink identifier and a radio network identifier of the first terminal device can be determined and stored by the network node. Similarly, the network node may receive a sidelink identifier of the second terminal device from the second terminal device which is served by the network node, and can determine a mapping relationship between the sidelink identifier and the corresponding radio network identifier of the second terminal device. Optionally, the network node may forward at least one of the received sidelink identifiers to other network node (e.g., MME, AMF or any other network entity with mobility management functionality). The other network node may store the mapping between the sidelink layer-2 ID, the Uu ID and the serving cell/node of each terminal device.

Optionally, the similarity signaling received by the network node from the first terminal device may further comprise other information about the second terminal device, for example, the RRC connection status, the absolute and/or relative position, the serving network node, etc. According to an exemplary embodiment, the second terminal device is operated in an RRC connected mode.

In an embodiment, based at least in part on the similarity signaling, the network node may determine whether to perform handover preparation for the second terminal device, as shown in block 504. Optionally, the network node can also determine whether to perform handover preparation for the first terminal device, based at least in part on the similarity signaling. In an exemplary embodiment where the second terminal device is served by the network node, the network node can determine to perform the handover preparation for the second terminal device. In accordance with some exemplary embodiments, the network node can select one or more candidate network nodes to perform the handover preparation, for example, according to at least one of measurement reports of the first terminal device and the second terminal device. Optionally, the selection of the one or more candidate network nodes may also be performed based at least in part on a service configuration (e.g., QoS and/or security requirement, etc.) of the first terminal device and/or the second terminal device.

In an exemplary embodiment where the second terminal device is served by another network node, the network node can determine not to perform the handover preparation for the second terminal device. Optionally, the network node may inform said another network node to perform the handover preparation for the second terminal device. As an example, the network node may provide the identifier of the second terminal device to an upper node (e.g., MME or AMF) to request inter-cell coordination for HO. The upper node can identify and inform said another network node that HO preparation may need to be performed for the second terminal device.

In the proposed solution according to one or more exemplary embodiments, taking the advantage of the proposed mobility optimization with the aid of sidelink makes it possible to perform HO preparation for UEs with similar mobility behavior. In this way, mobility related information of several UEs exchanged over sidelink can be efficiently utilized to improve HO performance of the UEs, and the system robustness and user experience can be improved accordingly.

The various blocks shown in FIGS. 4-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a terminal device as described with respect to FIG. 4 or a network node as described with respect to FIG. 5.

In some implementations, the one or more memories 602 and the computer program codes 603 may be configured to, with the one or more processors 601, cause the apparatus 600 at least to perform any operation of the method as described in connection with FIG. 4. In other implementations, the one or more memories 602 and the computer program codes 603 may be configured to, with the one or more processors 601, cause the apparatus 600 at least to perform any operation of the method as described in connection with FIG. 5. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

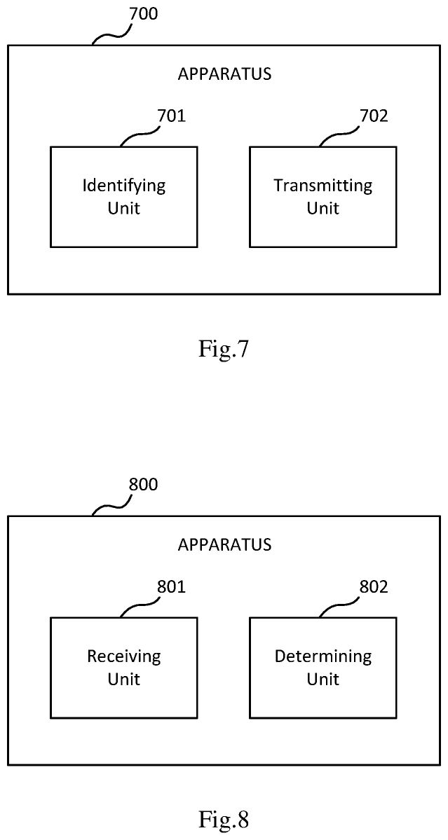

FIG. 7 is a block diagram illustrating an apparatus 700 according to some embodiments of the present disclosure. As shown in FIG. 7, the apparatus 700 may comprise an identifying unit 701 and a transmitting unit 702. In an exemplary embodiment, the apparatus 700 may be implemented in a terminal device such as UE. The identifying unit 701 may be operable to carry out the operation in block 402, and the transmitting unit 702 may be operable to carry out the operation in block 404. Optionally, the identifying unit 701 and/or the transmitting unit 702 may be operable to carry out more or less operations to implement the proposed methods according to the exemplary embodiments of the present disclosure.

FIG. 8 is a block diagram illustrating an apparatus 800 according to some embodiments of the present disclosure. As shown in FIG. 8, the apparatus 800 may comprise a receiving unit 801 and optionally a determining unit 802. In an exemplary embodiment, the apparatus 800 may be implemented in a network node such as a base station. The receiving unit 801 may be operable to carry out the operation in block 502, and the determining unit 802 may be operable to carry out the operation in block 504. Optionally, the receiving unit 801 and/or the determining unit 802 may be operable to carry out more or less operations to implement the proposed methods according to the exemplary embodiments of the present disclosure.

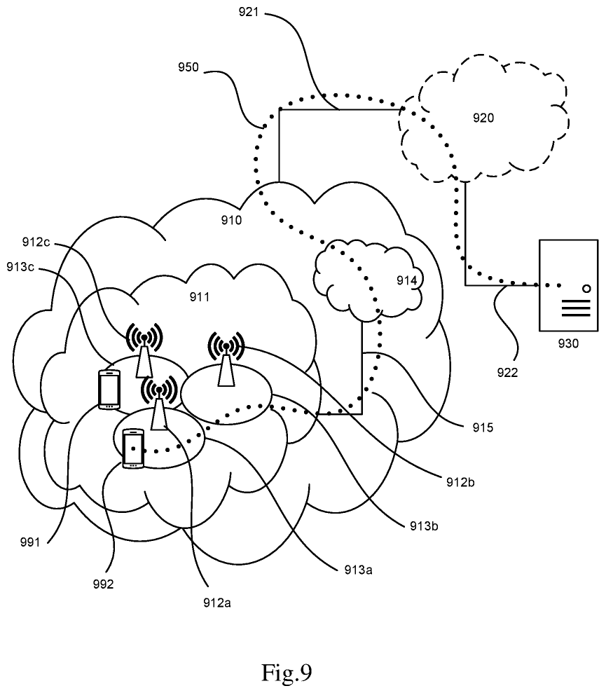

FIG. 9 is a block diagram illustrating a telecommunication network connected via an intermediate network to a host computer in accordance with some embodiments of the present disclosure.

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first UE 991 located in a coverage area 913c is configured to wirelessly connect to, or be paged by, the corresponding base station 912c. A second UE 992 in a coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. Connections 921 and 922 between the telecommunication network 910 and the host computer 930 may extend directly from the core network 914 to the host computer 930 or may go via an optional intermediate network 920. An intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, the base station 912 may not or need not be informed about the past routing of an incoming downlink communication with data originating from the host computer 930 to be forwarded (e.g., handed over) to a connected UE 991. Similarly, the base station 912 need not be aware of the future routing of an outgoing uplink communication originating from the UE 991 towards the host computer 930.

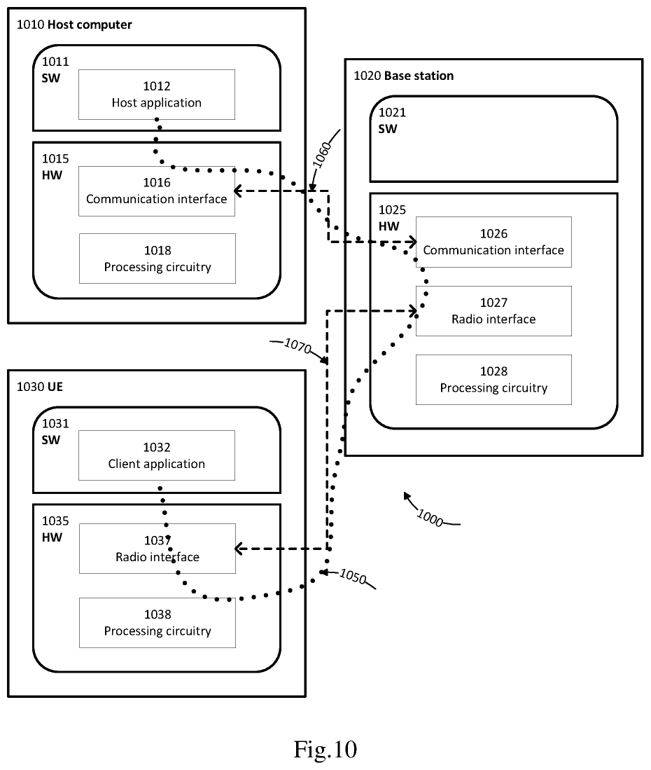

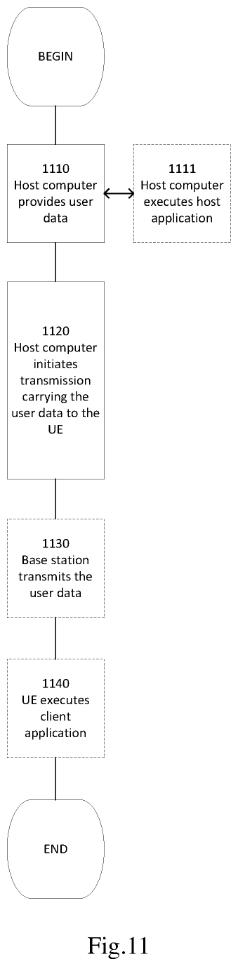

FIG. 10 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises a processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with the UE 1030 located in a coverage area (not shown in FIG. 10) served by the base station 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the base station 1020 further includes a processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes a processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, the base station 1020 and the UE 1030 illustrated in FIG. 10 may be similar or identical to the host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

Wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 1050 between the host computer 1010 and the UE 1030, in response to variations in the measurement results. The measurement procedure and/or the network functionality for reconfiguring the OTT connection 1050 may be implemented in software 1011 and hardware 1015 of the host computer 1010 or in software 1031 and hardware 1035 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which the software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer 1010's measurements of throughput, propagation times, latency and the like. The measurements may be implemented in that the software 1011 and 1031 causes messages to be transmitted, in particular empty or ‘dummy’ messages, using the OTT connection 1050 while it monitors propagation times, errors etc.

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

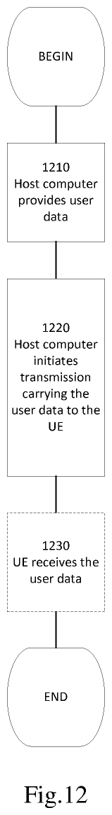

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

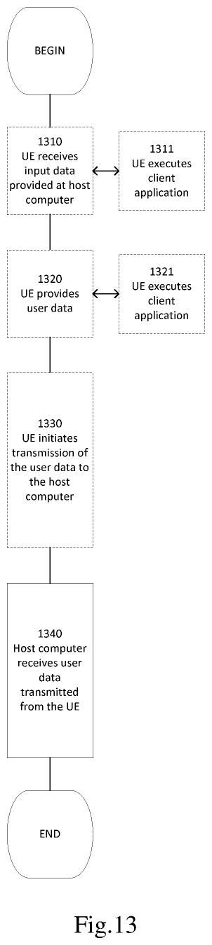

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

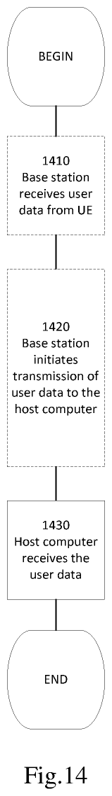

FIG. 14 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method implemented at a first terminal device, comprising:
identifying a second terminal device having a mobility behavior similarity to the first terminal device, wherein the mobility behavior similarity indicates that a difference in mobility behavior between the first terminal device and the second terminal device is within a predefined range; and
transmitting a similarity signaling which indicates the mobility behavior similarity to a network node serving the first terminal device.

2. The method according to claim 1, wherein the identification of the second terminal device is based at least in part on a message received by the first terminal device and indicating the mobility behavior similarity of the second terminal device.

3. The method according to claim 2, wherein the message indicating the mobility behavior similarity of the second terminal device comprises at least one of:
a broadcast message from the second terminal device;
a multicast message within a service group comprising at least the first terminal device and the second terminal device; and
a discovery message for a service group comprising at least the first terminal device and the second terminal device.

4. The method according to claim 1, wherein the mobility behavior similarity is represented by at least one of:
a position;
a moving path;
a moving direction; and
an associated service group.

5. (canceled)

6. The method according to claim 5, wherein the similarity signaling includes an identifier of the second terminal device and the identifier of the second terminal device comprises at least one of a sidelink identifier and a radio network identifier of the second terminal device.

7. The method according to claim 1, further comprising:
reporting a sidelink identifier of the first terminal device to the network node.

8. The method according to claim 1, further comprising:
obtaining at least one of a radio network identifier and radio resource control status of the second terminal device over a sidelink between the first terminal device and the second terminal device.

9. The method according to claim 8, wherein the radio network identifier of the second terminal device is obtained in a message containing a sidelink identifier of the second terminal device.

10. The method according to claim 1, further comprising:
informing at least one of a radio network identifier and radio resource control status of the first terminal device to the second terminal device over a sidelink between the first terminal device and the second terminal device.

11. The method according to claim 1, wherein the transmission of the similarity signaling to the network node is triggered by an event that signal quality measured by the first terminal device with respect to the network node is lower than a predefined threshold.

12. The method according to claim 1, further comprising:
announcing that the similarity signaling is transmitted to the network node by the first terminal device, so as to prevent the second terminal device from transmitting, to the network node, a similarity signaling indicating the mobility behavior similarity.

13. The method according to claim 1, further comprising:
suspending the transmission of the similarity signaling to the network node for a configurable period of time, in response to an announcement that the second terminal device transmits, to the network node, a similarity signaling indicating the mobility behavior similarity.

14. The method according to claim 1, wherein the second terminal device is served by the network node and transmits a sidelink identifier of the second terminal device to the network node.

15. (canceled)

16. The method according to claim 1, wherein the similarity signaling transmitted by the first terminal device further indicates at least one of:
a radio resource control status of the second terminal device;
a position of the second terminal device;
a distance between the first terminal device and the second terminal device; and
an identifier of a network node serving the second terminal device.

17. The method according to claim 1, wherein the similarity signaling transmitted from the first terminal device to the network node is used by the network node to determine whether to perform handover preparation for the first terminal device.

18.-32. (canceled)

33. An apparatus implemented in a first terminal device, comprising:
one or more processors; and
one or more memories comprising computer program codes,
the one or more memories and the computer program codes configured to, with the one or more processors, cause the apparatus at least to:
identify a second terminal device having a mobility behavior similarity to the first terminal device, wherein the mobility behavior similarity indicates that a difference in mobility behavior between the first terminal device and the second terminal device is within a predefined range; and
transmit a similarity signaling which indicates the mobility behavior similarity to a network node serving the first terminal device.

34. The apparatus according to claim 33, wherein the one or more memories and the computer program codes are configured to, with the one or more processors, cause the apparatus to perform 17 operations further comprising:
obtain at least one of a radio network identifier and radio resource control status of the second terminal device over a sidelink between the first terminal device and the second terminal device.

35. (canceled)

36. An apparatus implemented in a network node, comprising:
one or more processors; and
one or more memories comprising computer program codes,
the one or more memories and the computer program codes configured to, with the one or more processors, cause the apparatus at least to:
receive, from a first terminal device being served by the network node, a similarity signaling to indicate that the first terminal device has a mobility behavior similarity to a second terminal device, wherein the mobility behavior similarity indicates that a difference in mobility behavior between the first terminal device and the second terminal device is within a predefined range.

37. (canceled)

38. (canceled)

39. The method according to claim 34, wherein the radio network identifier of the second terminal device is obtained in a message containing a sidelink identifier of the second terminal device.

40. The method according to claim 33, wherein the one or more memories and the computer program codes are configured to, with the one or more processors, cause the apparatus to perform operations further comprising:
inform at least one of a radio network identifier and radio resource control status of the first terminal device to the second terminal device over a sidelink between the first terminal device and the second terminal device.
